(19) United States
(12) Patent Application Publication
(10) Pub. No.: US 2010/0184442 A1
(43) Pub. Date: Jul. 22, 2010

(54) COMMUNICATION METHOD AND, TERMINAL APPARATUS AND BASE STATION APPARATUS USING THE METHOD

(76) Inventors: Ken Nakaoka, Aichi (JP); Seigo Nakao, Kanagawa (JP)

Correspondence Address: MCDERMOTT WILL & EMERY LLP, 600 13TH STREET, N.W., WASHINGTON, DC, 20005-3096, US

(21) Appl. No.: 12/446,191

(22) PCT Filed: Oct. 9, 2007
(86) PCT No.: PCT/JP2007/001094

§ 371 Date: Jun. 18, 2009

(30) Foreign Application Priority Data
Oct. 18, 2006 (JP) 2006-284422

(51) Int. Cl. H04W 40/00

(52) U.S. Cl. 455/445

(57) ABSTRACT

A packet communication unit (20) executes radio communications in such a manner as to be accessible to other terminal apparatuses that have already been communicating wirelessly with a base station apparatus. The signal processing unit (22) generates a connection request signal to be transmitted from the packet communication unit (20) to the base station apparatus by way of the other terminal apparatuses. The signal processing unit (22) processes a connection response signal received, from the base station apparatus, by the packet communication unit 20. Such a sequence of operations allows the signal processing unit (22) to perform connection processing between a terminal apparatus and the base station apparatus.

### TECHNICAL FIELD

The present invention relates to a communication technology, and it particularly relates to a method for communicating signals between a base station apparatus and terminal apparatuses, and the terminal apparatus and the base station apparatus using the communication method.

### BACKGROUND TECHNOLOGY

A road-to-vehicle communication system includes a mobile station apparatus mounted on a vehicle and a base station apparatus placed on a street. A communication range in the road-to-vehicle communication system is limited. And if a communication range larger than the limited communication range is required, a plurality of base station apparatuses are placed and linked together. Provision of a management apparatus for collectively managing a plurality of base station apparatuses simplifies authentication processing performed when a mobile station apparatus is handed over among the base station apparatuses managed by this management apparatus (see Patent Document 1, for instance)

[Patent Document 1] Japanese Patent Application Laid-Open No. 2002-112337.

### DISCLOSURE OF THE INVENTION

Problems to be Solved by the Invention

In a wireless communication system structured by a babes station apparatus and a terminal apparatus, a connection processing is generally performed prior to a communication. An example of such a connection processing is executed as follows. The terminal apparatus transmits an authentication request signal to the base station apparatus. And when the base station apparatus executes the authentication processing, the base station apparatus transmits an authentication response signal to the terminal apparatus. Then the terminal apparatus transmits a connection request signal to the base station apparatus. And when the base station apparatus executes the connection processing, the base station apparatus transmits a connection response signal to the terminal apparatus. Note that the meaning of the term “connection processing” may be twofold. That is, there are a case where the connection processing is executed after the authentication processing and a case where the authentication and the connection processing are generically referred to as “connection processing. Hereinbelow, the term “connection processing” will be used without distinction between the two cases.

A predetermined period is required from the start of a connection processing until the completion thereof. instance, if a terminal apparatus is mounted on the vehicle and the terminal apparatus travels across a communication area formed by the base station apparatus as in the above-mentioned road-to-vehicle communication system, there may be cases where the terminal apparatus moves out of the communication area even when the communication starts after the connection processing has been completed. In such a case, the communication between the base station apparatus and the terminal apparatus is not effectively executed in the communication area.

The present invention has been made in view of such circumstances and a purpose thereof is to provide a communication technique by which to shorten the length of time needed for connection processing between a base station apparatus and a terminal apparatus in a communication area formed by the base station apparatus.

### MEANS FOR SOLVING THE PROBLEMS

In order to resolve the above problems, a terminal apparatus according to one embodiment of the present invention comprises: a communication unit which executes radio communication in such a manner as to be accessible to another terminal apparatus that has already been communicating wirelessly with a base station apparatus; and a processing unit which generates a signal to be transmitted from the communication unit to the base station apparatus by way of the another terminal apparatus and which processes a signal received from the base station apparatus by way of the another terminal apparatus.

“In such a manner as to be accessible to another terminal apparatus” indicates the following. That is, the communication unit may directly access the another terminal apparatus or it may indirectly access the another terminal apparatus by way of still another terminal apparatus. In other words, it suffices as long as a path leading to the another terminal apparatus is formed. According to this embodiment, communication is performed between the base station apparatus and a terminal apparatus by way of the another terminal apparatus, so that communication can be performed even outside a communication area of the base station apparatus.

Another embodiment of the present invention relates also to a terminal apparatus. This terminal apparatus comprises: a communication unit which executes radio communication in such a manner as to be accessible to another terminal apparatus that has already been communicating wirelessly with a base station apparatus; and a processing unit which generates a connection request signal to be transmitted from the communication unit to the base station apparatus by way of the another terminal apparatus and which executes connection processing between the base station apparatus and a terminal apparatus in such a manner that a connection response signal received from the base station apparatus by way of the another terminal apparatus is processed by the communication unit.

According to this embodiment, connection processing between the base station apparatus and the terminal apparatus is executed by way of the another terminal apparatus. As a result, the connection processing with the base station apparatus can be executed even outside the communication area of the base station apparatus. Thus, the length of time needed for connection processing between the base station apparatus and the terminal apparatus in the communication area formed by the base station apparatus can be shortened.

Prior to the connection processing, the communication unit broadcasts a searching signal to search for a base station apparatus to be communicated and at least one of other terminal apparatuses included in a path to the base station apparatus; and the processing unit generates the searching signal in such a manner that a condition for the base station apparatus to be communicated and a condition for the at least one of other terminal apparatuses that is to transfer the searching signal are contained in the searching signal. In this case, the signal that contains the condition for the base station apparatus to be communicated and the condition for another terminal apparatus that is to transfer the searching signal is broadcast, so that the base station apparatus and the another apparatus that meet the conditions can be searched.

The processing unit may generate the searching signal and the connection request signal in a unified manner. In this case, the search processing and the connection processing are carried out in a unified manner, so that the length of time required for the both processings can be shortened.

A terminal apparatus may further comprise a detector which detects that a direct radio communication becomes feasible between the communication unit and the base station apparatus. When a detection has been made by the detector, the communication unit may execute the direct radio communication with the base station apparatus. In this case, when a direct radio communication with the base station apparatus becomes possible, the direct radio communication is executed and therefore the normal radio communication can be executed.

When the detection has been made by the detector and the connection processing has been completed, the processing unit may have the communication unit execute the direct radio communication with the base station apparatus using a connection processing result; and when the detection has been made by the detector but the detection processing has not been completed, the processing unit may have the communication unit complete the connection processing by directly communicating wirelessly with the base station apparatus and have the communication unit maintain radio communication performed by way of the another terminal apparatus. In this case, if the connection processing has not yet been completed, radio communication by way of the another terminal apparatus is also kept. Thus, the data communication can be executed continuously.

Still another embodiment of the present invention relates to a base station apparatus. This apparatus comprises: a communication unit which executes radio communication with a terminal apparatus; and a processing unit which executes connection processing for a terminal apparatus that is to communicate wirelessly with the communication unit. The communication unit receives a connection request signal from another terminal apparatus by way of a terminal apparatus that has already been communicating wirelessly with the base station apparatus; and the processing unit executes connection processing for the another terminal apparatus, based on the connection request signal received by the communication unit, and the processing unit transmits a connection response signal from the communication unit to the another terminal apparatus by way of the terminal apparatus.

According to this embodiment, connection processing between the another terminal apparatus and the base station apparatus is executed by way of a terminal apparatus that has already been communicating wirelessly with the base station apparatus. As a result, the connection processing between the another terminal and the base station apparatus can be executed even outside the communication area of the base station apparatus. Thus, the length of time needed for connection processing between the base station apparatus and the terminal apparatus in the communication area formed by the base station apparatus can be shortened.

Prior to the connection processing, the communication unit may receive a searching signal to search for a base station apparatus to be communicated, the searching signal having been transferred by the terminal apparatus after transmitted by the another terminal apparatus; and the processing unit may include a means for determining the execution of connection processing for the another terminal apparatus when a condition, for the base station apparatus to be communication, contained in the searching signal received by the communication unit is met, and by referencing information, on a terminal apparatus that has transferred the searching signal, contained in the searching signal received by the communication unit, the processing unit transmits a response signal for the searching signal to the terminal apparatus. In this case, the condition for a base station apparatus to be communicated is received, so that the communication between a terminal apparatus and the base station apparatus that meets the condition can be provided.

The searching signal and the connection request signal received by the communication unit may be generated in a unified manner; and the processing unit may determine the execution of connection processing for the another terminal apparatus and execute the connection processing. In this case, the search processing and the connection processing are carried out in a unified manner, so that the length of time required for the both processings can be shortened.

A base station apparatus may further comprise a detector which detects that a direct radio communication becomes feasible between the communication unit and the another terminal apparatus. When a detection has been made by the detector, the communication unit may execute the direct radio communication with the another station apparatus. In this case, when a direct radio communication with the another terminal apparatus becomes possible, the direct radio communication is executed and therefore the normal radio communication can be executed.

When the detection has been made by the detector and the connection processing has been completed, the processing unit may have the communication unit execute the direct radio communication with the another terminal apparatus using a connection processing result; when the detection has been made by the detector but the detection processing has not been completed, the processing unit may have the communication unit complete the connection processing by directly communicating wirelessly with the another terminal apparatus and have the communication unit maintain radio communication performed by way of the terminal apparatus. In this case, if the connection processing has not yet been completed, radio communication by way of the terminal apparatus is also kept. Thus, the data communication can be executed continuously.

Still another embodiment of the present invention relates to a communication method. This method comprises: executing radio communication in such a manner as to be accessible to another terminal apparatus that has already been communicating wirelessly with a base station apparatus; generating a signal to be transmitted to the base station apparatus by way of the another terminal apparatus; and processing a signal received from the base station apparatus by way of the another terminal apparatus.

Still another embodiment of the present invention relates also to a communication method. This method comprises: executing radio communication in such a manner as to be accessible to another terminal apparatus that has already been communicating wirelessly with a base station apparatus; executing connection processing between the base station apparatus and a terminal apparatus in such a manner that a connection response signal to be transmitted to the base station apparatus by way of the another terminal apparatus is generated and a connection response signal received from the base station apparatus by way of the another terminal apparatus is processed.

A communication method may further comprise: broadcasting a searching signal to search for a base station apparatus to be communicated and at least one of other terminal apparatuses included in a path to the base station apparatus, prior to the connection processing; and generating the searching signal in such a manner that a condition for the base station apparatus to be communicated and a condition for the at least one of other terminal apparatuses that is to transfer the searching signal are contained in the searching signal.

The searching signal and the connection request signal may be generated in a unified manner. A communication method may further comprise detecting that a direct radio communication becomes feasible between the base station apparatus and a terminal apparatus; and executing the direction radio communication with the base station apparatus when a detection has been made. When the detection has been made and the connection processing has been completed, the executing the direct radio communication with the base station apparatus may execute the direct radio communication with the base station apparatus using a connection processing result; and when the detection has been made but the detection processing has not been completed, the executing the direct radio communication with he base station complete the connection processing by directly communicating wirelessly with the base station apparatus and maintain radio communication performed by way of the another terminal apparatus.

Still another embodiment of the present invention relates also to a communication method. This method comprises: executing radio communication with a terminal apparatus; and executing connection processing for a terminal apparatus that is to execute radio communication. The executing radio communication receives a connection request signal from another terminal apparatus by way of a terminal apparatus that has already been communicating wirelessly; and the executing connection processing executes connection processing for the another terminal apparatus, based on the received connection request signal, and transmits a connection response signal to the another terminal apparatus by way of the terminal apparatus.

A communication method may further comprise: receiving a searching signal to search for a base station apparatus to be communicated, the searching signal having been transferred by the terminal apparatus after transmitted by the another terminal apparatus, prior to the connection processing; determining the execution of connection processing for the another terminal apparatus when a condition, for the base station apparatus to be communication, contained in the received searching signal is met; and the processing unit transmits a response signal for the searching signal to a terminal apparatus by referencing information, on the terminal apparatus that has transferred the searching signal, contained in the received searching signal.

The searching signal and connection request signal received may be generated in a unified manner, and a communication method may further comprise determining the execution of connection processing for the another terminal apparatus and executing the connection processing. A communication method may further comprise detecting that a direct radio communication becomes feasible between the another terminal apparatus and a base station; and executing the direct radio communication with the another station apparatus when a detection has been made. When the detection has been made and the connection processing has been completed, the executing the direction radio communication with the another terminal apparatus may execute the direct radio communication with the another terminal apparatus using a connection processing result; when the detection has been made but the detection processing has not been completed, the executing the direction radio communication with the another terminal apparatus may complete the connection processing by directly communicating wirelessly with the another terminal apparatus and maintain radio communication performed by way of the terminal apparatus.

Optional combinations of the aforementioned constituting elements, and implementations of the invention in the form of methods, apparatuses, systems, recording mediums, computer programs and so forth may also be effective as additional modes of the present invention.

### ADVANTAGE OF THE INVENTION

The length of time needed for connection processing between a base station apparatus and a terminal apparatus in a communication area formed by the base station apparatus can be shortened.

### BRIEF DESCRIPTION OF THE DRAWINGS

FIGS. 1(a) and 1(b) are diagrams each showing a structure of a communication system according to an exemplary embodiment of the present invention.

FIG. 2 is a diagram showing a structure of a first terminal apparatus shown in FIG. 1.

FIG. 3 is a diagram showing a data structure of data stored in an information storage shown in FIG. 2.

FIG. 4 is a diagram showing a structure of a base station apparatus shown in FIG. 1.

FIG. 5 is a sequence diagram showing a procedure up to a connection in a communication system shown in FIG. 1.

FIGS. 6(a) to 6(d) are diagrams each showing a structure of packet signal transmitted by the communication system of FIG. 1.

FIG. 7 is a flowchart showing a procedure for transmitting packet signals in a first terminal apparatus shown in FIG. 1.

FIG. 8 is a flowchart showing a procedure for transferring a search request packet signal in a second terminal apparatus and a third terminal apparatus shown in FIG. 1.

FIG. 9 is a flowchart showing a procedure for processing a search request packet signal and a search response packet signal in a base station apparatus shown in FIG. 1.

FIG. 10 is a flowchart showing a procedure for transferring a search response packet signal in a second terminal apparatus and a third terminal apparatus shown in FIG. 1.

FIG. 11 is a flowchart showing a procedure for processing a search response packet signal and an authentication request packet signal in a first terminal apparatus shown in FIG. 1.

FIG. 12 is a flowchart showing a procedure for transferring an authentication request packet signal or authentication response packet signal in a second terminal apparatus and a third terminal apparatus shown in FIG. 1.

FIG. 13 is a flowchart showing a procedure for processing an authentication request packet signal and an authentication response packet signal in a base station apparatus shown in FIG. 1.

FIG. 14 is a flowchart showing a procedure for processing an authentication response packet signal and a connection request packet signal in a first terminal apparatus shown in FIG. 1.

FIG. 15 is a flowchart showing a procedure for transferring a connection request packet signal or connection response packet signal in a second terminal apparatus and a third terminal apparatus shown in FIG. 1.

FIG. 16 is a flowchart showing a procedure for processing a connection request packet signal and a connection response packet signal in a base station apparatus shown in FIG. 1.

FIG. 17 is a flowchart showing a procedure for receiving a connection response packet signal in a first terminal apparatus shown in FIG. 1.

FIG. 18 is a flowchart showing a procedure for processing a first terminal apparatus when the first terminal apparatus enters into a communication area of a base station apparatus shown in FIG. 1.

FIG. 19 is a flowchart showing a procedure for processing a base station apparatus when a first terminal apparatus enters into a communication area of the base station apparatus shown in FIG. 1.

FIG. 20 is a sequence diagram showing a processing procedure up to a connection in a modification.

FIGS. 21(a) and 21(b) are diagrams each showing a structure of packet signal transmitted by a communication system shown in FIG. 20.

FIG. 22 is a flowchart showing a procedure for transmitting a packet signal in a first terminal apparatus shown in FIG. 20.

FIG. 23 is a flowchart showing a procedure for transferring a search authentication request packet signal in a second terminal apparatus and a third terminal apparatus shown in FIG. 20.

FIG. 24 is a flowchart showing a procedure for processing a search authentication request packet signal and a search authentication response packet signal in a base station apparatus shown in FIG. 20.

### DESCRIPTION OF THE REFERENCE NUMERALS

10 Terminal apparatus, 12 Base station apparatus, 14 Terminal antenna, 16 Base-station antenna, 20 Packet communication unit, 22 Signal processing unit, 24 Information storage, 26 Vehicle information management unit, 28 Vehicle sensor unit, 30 Packet receiver, 32 Packet transmitter, 34 Packet processing unit, 36 Packet generator, 50 Packet communication unit, 52 Signal processing unit, 54 Wired communication unit , 56 Packet receiver, 58 Packet transmitter, 60 Packet processing unit, 62 Packet generator, 64 Control unit, 100 Communication system.

### BEST MODE FOR CARRYING OUT THE INVENTION

An outline of the present invention will be given before a specific description thereof. Exemplary embodiments of the present invention relate to a communication system comprised of a base station apparatus and terminal apparatuses. An area within which a terminal apparatus can communicate with the base station apparatus is defined to be a communication area. The communication area generally has an approximately circular shape with the base station apparatus as its center. As a terminal apparatus enters the communication area, connection processing is performed between the terminal apparatus and the base station apparatus and then communications are carried out between them. When the terminal apparatus travels across the communication area, there are cases where the connection processing is completed just before the terminal apparatus leaves the communication area if the connection processing starts during an entry to the communication area. As a result, the amount of information that can be communicated between the terminal apparatus and the base station gets smaller. For that reason, the communication system according to the present exemplary embodiment execute the following processings.

Before the terminal apparatus enters the communication area, another terminal (hereinafter referred to as “transfer apparatus”) and the base station apparatus communicate with each other in the communication area. Assume that the transfer apparatus lies within the communication area and is in a position capable of communicating with the terminal apparatus. The terminal apparatus performs connection processing with the base station apparatus by way of the transfer apparatus. In other words, signals transmitted from the terminal apparatus are relayed by the transfer apparatus and then received by the base station apparatus. Also, signals transmitted from the base station apparatus are relayed by the transfer apparatus and then received by the terminal apparatus. If the terminal apparatus travels across the communication area as described above, the terminal apparatus will be able to complete the connection processing with the base station apparatus before entering the communication area or immediately after having entered it. Then the terminal apparatus directly communicates with the base station apparatus in the communication area.

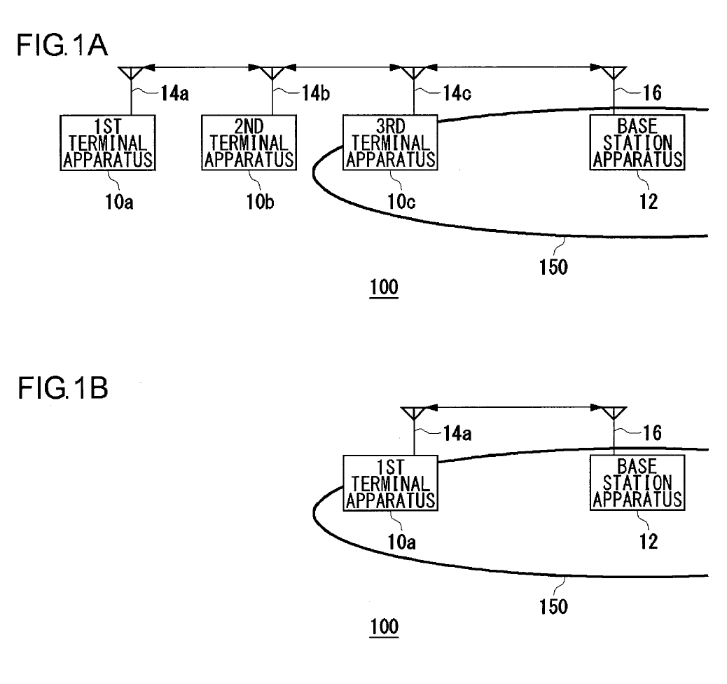

FIGS. 1(a) and 1(b) each shows a structure of a communication system 100 according to the present exemplary embodiment of the present invention. The communication system 100 includes a first terminal apparatus 10a, a second terminal apparatus 10b, and a third terminal apparatus 10c, which are generically referred to as “terminal apparatus 10”, and a base station apparatus 12. The first terminal apparatus 10a includes a first terminal antenna 14a; the second terminal apparatus 10b includes a second terminal antenna 14b; the third terminal apparatus 10c includes a third terminal antenna 14c; and the base station apparatus 12 includes a base-station antenna 16. Here, the first terminal antenna 14a, the second terminal antenna 14b and the third terminal antenna 14c are generically referred to as “terminal antenna 14”. A communication area 150 is formed by the base station apparatus 12. And a terminal apparatus 10 existing in the communication area 150 is capable of communicating with the base station apparatus 12. Note that the second terminal apparatus 10b and the third terminal apparatus 10c correspond to the above-described transfer apparatus. For example, the terminal apparatus 10 is mounted on a vehicle or the like.

FIG. 1(a) shows a case where the first terminal apparatus 10a lies outside the communication area 150. The third terminal apparatus 10c, which lies within the communication area 150, is capable of communicating with the base station apparatus 12. On the other hand, the first terminal apparatus 10a is accessible to the third terminal apparatus 10c by way of the second terminal apparatus 10b. In this manner, the first terminal apparatus 10a is indirectly accessible to the base station apparatus 12 by the signals transferred by the second terminal apparatus 10b and the third terminal apparatus 10c. Under such circumstances, the first terminal apparatus 10a and the base station apparatus 12 perform connection processing by way of the second terminal apparatus 10b and the third terminal apparatus 10c. The detailed description of connection processing will be discussed later.

FIG. 1(b) shows a state subsequent to that of FIG. 1(a) and corresponds to a case where the first terminal apparatus 10a enters into the communication area 150 as it moves toward the base station apparatus 12. In the processing of FIG. 1(a), if the connection processing between the first terminal apparatus 10a and the base station apparatus 12 has been completed and if the state of FIG. 1(a) transits to the state of FIG. 1(b), the first terminal apparatus 10a and the base station apparatus 12 will instantly communicate with each other. That is, as the first terminal apparatus 10a enters the communication area 150, the first terminal apparatus 10a is capable of communicating with the base station apparatus 12.

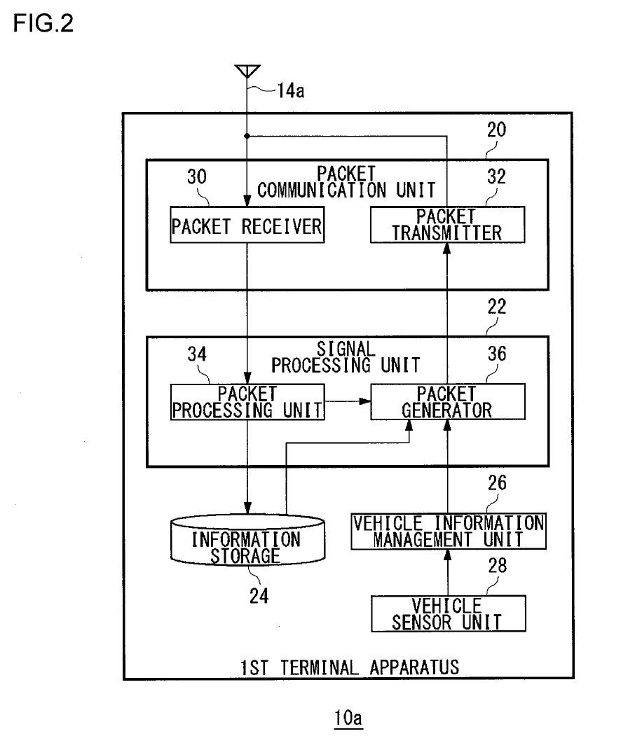

FIG. 2 shows a structure of a first terminal apparatus 10a. The first terminal apparatus 10a includes a first terminal antenna 14a, a packet communication unit 20, a signal processing unit 22, an information storage 24, a vehicle information management unit 26, and a vehicle sensor unit 28. The packet communication unit 20 includes a packet receiver 30 and a packet transmitter 32. The signal processing unit 22 includes a packet processing unit 34 and a packet generator 36. Note that the second terminal apparatus 10b and the third terminal apparatus 10c each have the similar structure to that shown in FIG. 2.

The packet receiver 30 performs demodulation processing and the like on a packet signal received by the first terminal antenna 14a. Since the packet signal received by the first terminal antenna 14a is a radiofrequency-domain signal, the packet receiver 30 carries out frequency conversion of the packet signal from the radiofrequency domain to the baseband domain. Then, the packet is subjected to demodulation processing and decoding processing, and a packet signal defined in an upper layer than a physical layer is outputted to the packet processing unit 34.

The packet processing unit 34 receives the packet signals from the packet receiver 30, and performs processings, in an upper layer, such as a path control, according to packet signals contained in the received packet signals. The upper layer corresponds to a layer which is defined higher than the physical layer. The content of processing done in the upper layer will be discussed later. The packet processing unit 34 outputs processing results to the information storage 24 and, at the same time, gives instructions to the packet generator 36 about the next processing based on the processing results, particularly about the generation of packets to be transmitted.

The vehicle sensor unit 28 corresponds to a GPS (Global Positioning System) and acquires successively the present positions of the first terminal apparatus 10a. Note that it is only necessary for the vehicle sensor unit 28 to acquire the present position, and the vehicle sensor unit 28 is not limited to the GPS. The vehicle information management unit 26 stores the present positions acquired by the vehicle sensor unit 28 and derives the traveling direction of the first terminal apparatus 10a from the present and past positions. For example, the coordinates of the past position are derived from the coordinates of the present position by vector subtraction.

The information storage 24 stores the processing results obtained in the packet processing unit 34. The detail will be discussed later. While referring to storage contents stored in the information storage 24, the packet generator 36 generates packet signals in accordance with instructions from the packet processing unit 34. Depending on the type of packet signals to be generated, there may be cases where the information managed by the vehicle information management unit 26 is used. Packet signals generated by the packet generator 36 are equivalent to packet signals defined in an upper layer than the physical layer, in correspondence to packet signals inputted to the packet processing unit 34. The packet generator 36 outputs the generated packet signals to the packet transmitter 32.

The packet transmitter 32 codes and modulates the packet signals outputted from the packet generator 36. Also, the packet transmitter 32 carries out frequency conversion of the modulated packet signals from the baseband domain to the radiofrequency domain. Then, the packet transmitter 32 transmits the frequency-converted packet signals from the first terminal antenna 14a. The processings performed by the packet receiver 30 and the packet transmitter 32 correspond to a radio communication processing. And in the above-mentioned FIG. 1(a) the radio communication is so performed as to be accessible to another terminal apparatus 10 which has already been performing wireless communication with the base station apparatus 12.

The processing carried out by the first terminal apparatus 10a before the first terminal apparatus 10a communicates with the base station apparatus 12 is mainly divided into three types. Listing the three types in order of the processing carried out, they are (1) search processing (2) authentication processing and (3) connection processing. The search processing is a processing that searches for a base station apparatus to be communicated and other terminal apparatuses 10 included in a path leading to the base station apparatus to be communicated. For example, in FIG. 1(a), the base station apparatus to be communicated corresponds to the base station apparatus 12, whereas the other terminal apparatuses 10 included in a path to the base station apparatus to be communicated correspond to the second terminal apparatus 10b and the third terminal apparatus 10c, namely the transfer apparatuses, included in the path between themselves and the base station apparatus 12. The authentication processing is a processing through which the base station apparatus 12 authenticates the first terminal apparatus 10a. The connection processing is a processing through which the base station apparatus 12 connects the first terminal apparatus 10a. In what is to follow, a description is given of the processing contents in the order of (1) to (3) by associating them with the structure of the first terminal apparatus 10a shown in FIG. 2. Further, the processings (4) and (5) carried out after an established connection are explained.

(1) Search Processing

In the search processing, a signal for use in search (hereinafter referred to as “search request packet signal” or “search request packet”) is generated to search a base station apparatus to be communicated and at least one of other terminal apparatuses 10 included in a path to said base station apparatus. Note that the search request packet signal contains a condition for the base station apparatus to be communicated and a condition for the other terminal apparatuses 10 that are to transfer the search request packet signal. The packet transmitter 32 broadcasts the search request packet signal. The condition for the base station apparatus to be communicated corresponds to the type of service supported in the base station apparatus, the distance from the first terminal apparatus 10a, the transmission rate executable in the base station apparatus, for instance. The condition for the other terminal apparatuses 10 that are to transfer the search request packet signal corresponds to the presence of the terminal apparatus 10 in the travelling direction. In order to produce these conditions, the packet generator 36 may use the information stored in the vehicle information management unit 26.

As other terminal apparatuses 10 (not shown) receive the search request packet signal, they verify the condition for the base station apparatus to be communicated and the condition for the other terminal apparatuses 10 that are to transfer the search request packet signal. In so doing, the packet generators 36 included in the other terminal apparatuses 10 reference the information stored in the vehicle information management units 26 included in the other terminal apparatuses 10. If any of the other terminal apparatuses 10 meets these conditions, the other terminal apparatus 10 will append the information on the terminal apparatus 10 itself (hereinafter this, too, will be referred to as “search request packet signal”) and then broadcast the search request packet signal. The above-described processing is repeated so as to form a path from the first terminal apparatus 10a to the base station apparatus 12.

On the other hand, the packet transmitter 32 receives a search response packet signal (hereinafter referred to as “search response packet” also) as a response signal to the search request packet signal. The search response packet signal is transmitted from the not-shown base station apparatus 12 to the first terminal apparatus 10a in such a manner that the search response packet signal is transferred through a path formed by the search request signal in the reverse direction to the search request packet. The packet processing unit 34 extracts the content of the search response packet signal. The search response packet signal contains information on the base station apparatus to be communicated and information on at least one of the other terminal apparatuses 10 contained in a path to this base station apparatus.

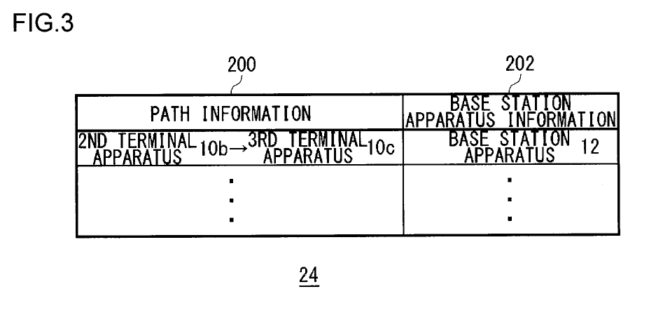

The information storage 24 stores data contained in the search response packet signal. FIG. 3 shows a data structure of data stored in the information storage 24. As shown in FIG. 3, a path information column 200, a base station apparatus information column 202 are contained. The information indicated in the base station apparatus information column 202 corresponds to the base station apparatus to be communicated, whereas the information indicated in the path information column 200 corresponds to the other terminal apparatuses 10 included in a path to the base station apparatus. The information shown in FIG. 3 corresponds to the state of FIG. 1(a) where the first terminal apparatus 10a reaches the base station apparatus 12 by way of the second terminal apparatus 10b and the third terminal apparatus 10c.

(2) Authentication processing and (3) connection processing

In the first terminal apparatus 10a and the transfer apparatus, similar processings are carried out as authentication processing and connection processing, respectively, and those processings will be described herein in a collective manner. The packet generator 36 generates an authentication request signal to be transmitted from the packet transmitter 32 to the base station apparatus 12 by way of the other terminal apparatuses 10. Hereinafter, this authentication request signal will be referred to as “authentication request packet signal” or “authentication request packet”. The packet transmitter 32 transmits the authentication request packet signal generated by the packet generator 36. The packet receiver 30 performs authentication processing with the base station apparatus 12 in a manner such that the packet receiver 30 receives an authentication response signal (hereinafter referred to as “authentication response packet signal” or “authentication response packet”) by way of the other terminal apparatuses 10 and the packet processing unit 34 processes the authentication response packet signal received by the packet receiver 30. Note that the authentication request packet signal contains a signal requesting authentication, and the authentication response packet signal contains a signal indicating that the authentication has been made.

The packet generator 36 generates a connection request signal to be transmitted from the packet transmitter 32 to the base station apparatus 12 by way of the other terminal apparatuses 10. Hereinafter, the connection request signal will be referred to as “connection request packet signal” or “connection request packet”. The packet transmitter 32 transmits the connection request packet signal generated by the packet generator 36. The packet receiver 30 performs connection processing with the base station apparatus 12 in a manner such that the packet receiver 30 receives a connection response signal (hereinafter referred to as “connection response packet signal” or “connection response packet”) by way of the other terminal apparatuses 10 and the packet processing unit 34 processes the connection response packet signal received by the packet receiver 30. Note that the connection request packet signal contains a signal requesting a connection, and the connection response packet signal contains a signal indicating that the connection has been established.

(4) Communication processing performed indirectly with the base station apparatus 12

After the completion of the above-described connection processing, if the state of FIG. 1(a) continues, namely, if the first terminal apparatus 10a has not yet entered into the communication area 150, the first terminal apparatus 10a will communicate with the base station apparatus 12 by way of the second terminal apparatus 10b and the third terminal apparatus 10c. Hereinafter, such a communication as this will be called “multi-hop communication”). In other words, the packet communication unit 20 communicates wirelessly with the second terminal apparatus 10b so that it is accessible to the other terminal apparatus 10 (namely, the third terminal apparatus 10c) which has already been wirelessly communicating with the base station apparatus 12. The packet generator 36 generates signals to be transmitted from the packet transmitter 32 to the base station apparatus 12 by way of the other terminal apparatuses 10. The packet processing unit 34 processes the packet signals received by the packet receiver 30 from the base station apparatus 12 by way of the other terminal apparatuses 10. Note that the packet signal contains predetermined data.

(5) Communication processing performed directly with the base station apparatus 12

A description is given of a case where the state of FIG. 1(a) transits to the state of the FIG. 1(b), namely, a case where the first terminal apparatus 10a enters into the communication area 150. The packet receiver 30 and the packet processing unit 34 detect that direct radio communication becomes possible between the base station apparatus 12 and the first terminal apparatus 10a. More specifically, demodulation is executed after a beacon signal is received by the packet receiver 30 and then a demodulation result is outputted to the packet processing unit 34. The packet processing unit 34 extracts, from the demodulation result, the identification information of the base station apparatus that has sent said beacon signal. The packet processing unit 34 compares this identification information with the information on base station apparatuses stored in the information storage 24. If they agree, the packet processing unit 34 will detect that the direct radio communication becomes possible between the base station apparatus 12 and the first terminal apparatus 10a.

If detected, the packet communication unit 20 and the signal processing unit 22 will perform direct radio communication with the base station apparatus 12 (hereinafter, such communication as this will be referred to as “direct communication”). The signal processing unit 22 controls the switching of the communication mode by the packet communication unit 20 to the direct communication from the multi-hop communication that has been executed so far. The switching control differs depending on how far the processings have been completed among the above-described search processing, the authentication processing and the connection processing. If detected and the entire connection processing has been completed, the signal processing unit 22 will have the packet communication unit 20 switch the communication mode from the multi-hop communication to the direct communication, using the results of the connection processing stored in the information storage 24. On the other hand, if detected but the connection processing has not been completed thoroughly, the signal processing unit 22 will have the packet communication unit 20 complete the remaining connection processing while having it execute the direct communication, and also will have it maintain the multi-hop communication. In such multi-hop communication as this, data other than those on the connection processing are communicated.

This structure may be implemented hardwarewise by elements such as a CPU, memory and other LSIs of an arbitrary computer, and softwarewise by memory-loaded programs having communication functions or the like. Depicted herein are functional blocks implemented by cooperation of hardware and software. Therefore, it will be obvious to those skilled in the art that the functional blocks may be implemented by a variety of manners including hardware only, software only or a combination of both.

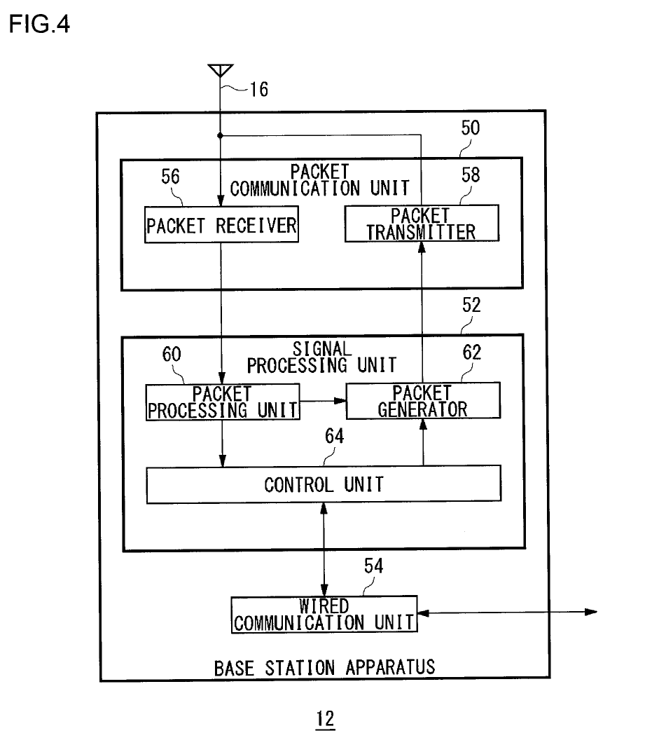

FIG. 4 shows a structure of a base station apparatus 12. The base station apparatus 12 includes a base-station apparatus antenna 16, a packet communication unit 50, a signal processing unit 52, and a wired communication unit 54. The packet communication unit 50 includes a packet receiver 56 and a packet transmitter 58. The signal processing unit 52 includes a packet processing unit 60, a packet generator 62, and a control unit 64.

The packet receiver 56 performs processing similar to that of the above-described packet receiver 30, whereas the packet transmitter 58 performs processing similar to that of the above-described packet transmitter 32. Note that the packet transmitter 58 transmits a beacon signal at regular intervals. The beacon signal contains information with which to identify the base station apparatus 12.

The packet processing unit 60 receives a packet signal from the packet receiver 56, and performs processing for an upper layer, such as path control, according to the packet signal contained in the received packet signal. The upper layer corresponds to a layer defined upper than a physical layer. The content of processing in the upper layer will be discussed later in detail. The packet processing unit 60 outputs a processing result to the control unit 64. The control unit 64 controls the operation of the entire base station apparatus 12, the connection processing for the terminal apparatus 10, and the like.

The packet generator 62 generates packet signals according to instructions from the control unit 64. Note that the packet signal generated by the packet generator 62, which corresponds to the packet signal inputted to the packet processing unit 60, is equivalent to a packet signal defined in a layer upper than a physical layer. The packet generator 62 outputs the generated packet signal to the packet transmitter 58.

The wired communication unit 54 is connected to a not-shown wired network, and performs the wired communication that uses the wired network. That is, the wired communication unit 54 outputs data, sent from a not-shown terminal apparatus 10 and received by the packet communication unit 50 and the signal processing unit 52, to the wired network. Also, the wired communication unit 54 outputs data inputted from the wired network, to the signal processing unit 52. Note that the control of the wired communication unit 54 is performed by the control unit 64.

Though the processings for the first terminal apparatus 10a have already been described, processings corresponding to those processings are also carried out in the base station apparatus 12. To clarify the correspondence of the processings carried out in between the first terminal apparatus 10a and the base station apparatus 12, the processings in the base station apparatus 12 are also explained as follows by dividing them into (1) to (5).

(1) Search processing

The packet receiver 56 receives a search request packet signal which is transmitted from the not-shown first terminal apparatus 10a and then transferred by the transfer apparatus. As described above, the search request packet signal is a signal used to search for a base station apparatus to be communicated. The packet receiver 56 outputs the received search request packet signal to the packet processing unit 60. Out of conditions contained in the search request packet signal, the packet processing unit 60 extracts the condition for the base station apparatus to be communicated and the information on the terminal apparatus 10 that have transferred the search request packet signal. If they meet the condition for the base station to be communicated, the control unit 64 will determine the execution of the connection processing for the first terminal apparatus 10a.

For example, if a service contained in the condition for the base station apparatus to be communicated is executable, the control unit 64 will determine that they have met the condition. When the control unit 64 has determined the execution of the connection processing, the control unit 64 instructs the packet generator 62 to generate a search response packet signal. The search response packet signal is a signal used to instruct the execution of connecting processing. The control unit 64 identifies a transfer apparatus that is to transfer the search response packet signal, based on the information on the terminal apparatus 10 that has transferred the search request packet signal. The packet generator 62 generates a search response packet signal. The packet transmitter 58 transmits the search response packet signal generated by the packet generator 62, to the transfer apparatus identified by the control unit 64.

(2) Authentication processing and (3) connection processing

The packet receiver 56 receives an authentication request packet signal sent from the not-shown first terminal apparatus 10a by way of the transfer apparatus that has already been communicating wireless with a base station apparatus 12. The signal processing unit 52 executes authentication processing for the first terminal apparatus 10a to be wirelessly communicated in the packet communication unit 50. That is, the signal processing unit 52 executes the authentication processing for the first terminal apparatus 10a based on the authentication request packet signal received by the packet receiver 56, and generates its result as the authentication response packet signal. The packet transmitter 58 transmits the authentication response packet signal to the first terminal apparatus 10a by way of the transfer apparatus.

The packet receiver 56 receives the connection request packet signal from the not-shown first terminal apparatus 10a by way of the transfer apparatus that has already been communicating wirelessly with the base station apparatus 12. The signal processing unit 52 executes connection processing for the first terminal apparatus to be wirelessly communicated in the packet communication unit 50. That is, the signal processing unit 52 executes the connection processing for the first terminal apparatus 10a based on the connection request packet signal received by the packet receiver 56, and generates its result as the connection response packet signal. The packet transmitter 58 transmits the connection response packet signal to the first terminal apparatus 10a by way of the transfer apparatus.

(4) Communication processing performed indirectly with the base station apparatus 12

The base station apparatus 12 performs multi-hop communication between the base station apparatus 12 and the first terminal apparatus 10a, by way of the transfer apparatus. The content of the multi-hop communication corresponds to what has been explained as to the first terminal apparatus 10a and therefore the explanation thereof is omitted here. The wired communication unit 54 communicates with the wired network as necessary.

(5) Communication processing performed directly with the base station apparatus 12

The packet receiver 56 and the packet processing unit 60 detect that direct radio communication becomes possible between the not-shown first terminal apparatus 10a and the base station apparatus 12. When the packet signal received by the packet receiver 56 is directly transmitted from the first terminal apparatus 10a, the packet processing unit 60 detects that direct radio communication becomes possible.

If detected, the packet communication unit 50 and the signal processing unit 52 will directly communicated wirelessly with the first terminal apparatus 10a. The signal processing unit 52 controls the switching of the communication mode by the packet communication unit 50 to the direct communication from the multi-hop communication that has been executed so far. The switching control differs depending on how far the processings have been completed among the above-described search processing, the authentication processing and the connection processing. If detected and the entire connection processing has been completed, the signal processing unit 52 will have the packet communication unit 50 switch the communication mode from the multi-hop communication to the direct communication, using the results of the connection processing. On the other hand, if detected but the connection processing has not been completed thoroughly, the signal processing unit 52 will have the packet communication unit 50 complete the remaining connection processing while having it execute the direct communication, and also will have it maintain the multi-hop communication. In such multi-hop communication as this, data other than those on the connection processing are communicated.

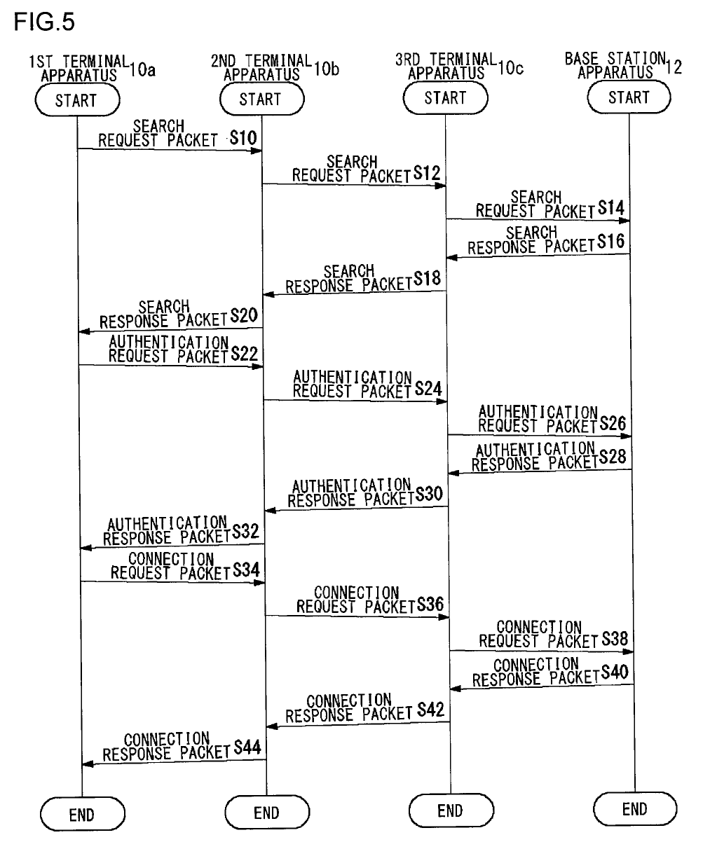

An operation of the communication system 100 structured as above is now explained. FIG. 5 is a sequence diagram showing a procedure up to a connection in the communication system 100. The first terminal apparatus 10a broadcasts a search request packet (S10). The second terminal apparatus 10b determines the transfer of the received search request packet, and broadcasts the search request packet (S12). The third terminal apparatus 10c determines the transfer of the received search request packet, and broadcasts the search request packet (S14). The base station apparatus 12 transmits a search response packet signal to the third terminal apparatus 10c (S16). The third terminal apparatus 10c transmits the search response packet signal to the second terminal apparatus 10b (S18). The second terminal apparatus 10b transmits the search response packet signal to the first terminal apparatus 10a (S20).

The first terminal apparatus 10a transmits an authentication request packet signal to the second terminal apparatus 10b (S22). The second terminal apparatus 10b transmits the authentication request packet signal to the third terminal apparatus 10c (S24). The third terminal apparatus 10c transmits the authentication request packet signal to the base station apparatus 12 (S26). The base station apparatus 12 authenticates the first terminal apparatus 10a and then transmits an authentication response packet signal to the third terminal apparatus 10c (S28). The third terminal apparatus 10c transmits the authentication response packet signal to the second terminal apparatus 10b (S30). The second terminal apparatus 10b transmits the authentication response packet signal to the first terminal apparatus 10a (S32).

The first terminal apparatus 10a transmits a connection request packet signal to the second terminal apparatus 10b (S34). The second terminal apparatus 10b transmits the connection request packet signal to the third terminal apparatus 10c (S36). The third terminal apparatus 10c transmits the connection request packet signal to the base station apparatus 12 (S38). The base station apparatus 12 connects the first terminal apparatus 10a and then transmits a connection response packet signal to the third terminal apparatus 10c (S40). The third terminal apparatus 10c transmits the connection response packet signal to the second terminal apparatus 10b (S42). The second terminal apparatus 10b transmits the connection response packet signal to the first terminal apparatus 10a (S44).

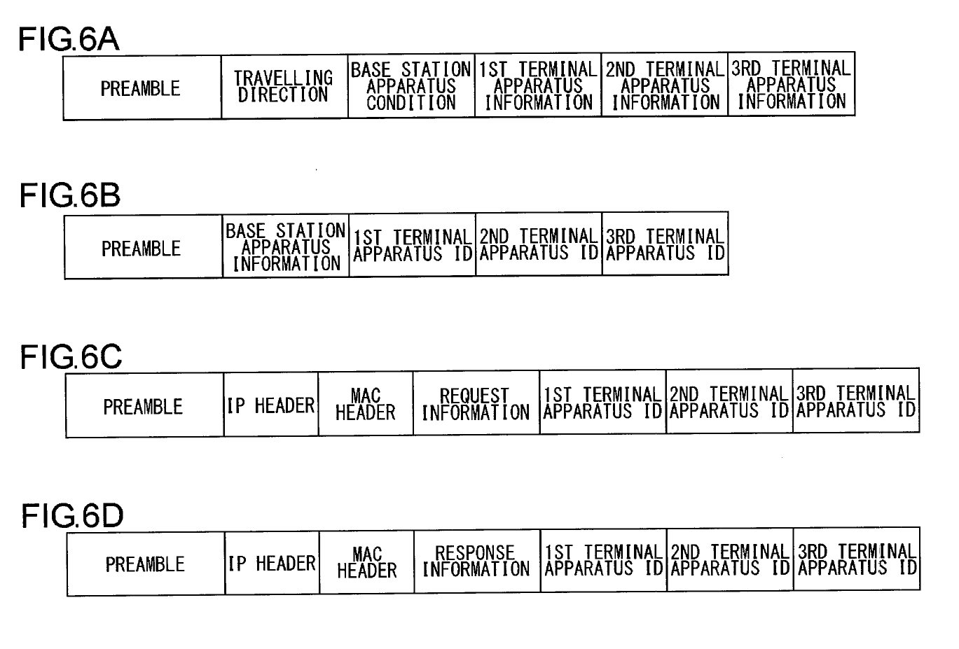

FIGS. 6(a) to 6(d) each shows a structure of packet signal transmitted by the communication system 100. FIG. 6(a) shows a format of search request packet signal. The search request packet signal includes a preamble in the physical layer, information on the travelling direction of the first terminal apparatus 10a, a condition for a base station apparatus to be communicated, and information on transfer apparatuses. The information on the travelling direction of the first terminal apparatus 10a corresponds to a condition for other terminal apparatuses 10 that are to transfer the above-described search request packet signal, and is generated by the vehicle information management unit 26. The information on transfer apparatuses corresponds to “first terminal apparatus information” through “third terminal apparatus information” in the format shown in the Figures. Note that the information on transfer apparatuses is appended to the rearmost part of the packet signal according to a corresponding terminal apparatus 10.

In other words, when the search request packet signal is broadcasted from the first terminal apparatus 10a, “first terminal apparatus information” only is appended posterior to “base station apparatus information”. When the search request packet signal is broadcasted from the second terminal apparatus 10b, “second terminal apparatus information” is appended posterior to “first terminal apparatus information”. When the search request packet signal is broadcasted from the third terminal apparatus 10c, “third terminal apparatus information” is appended posterior to “second terminal apparatus information”. As a result, the destination of a search response packet signal is specified by referencing the information on the transfer apparatus appended at the very end, namely the third terminal apparatus information.

FIG. 6(b) shows a format of search response packet signal. The search response packet signal includes a preamble in the physical layer, base station apparatus information, and transfer apparatus ID. The base station apparatus information is information on a base station apparatus 12 which has permitted access by receiving the search request packet signal. Based on this information, the first terminal apparatus 10a identifies a base station apparatus to be communicated. “First terminal apparatus ID” to “third terminal apparatus ID” used as transfer apparatus IDs are IDs associated with “first terminal apparatus information” to “third terminal apparatus information”, respectively. The transfer destination of the search response packet signal is specified based on the above-mentioned transfer apparatus ID. An arbitrary terminal apparatus 10 sequentially searches the transfer apparatus ID starting from the rearmost part of the received search response packet signal. The ID of a terminal apparatus 10 placed before the ID corresponding to the own terminal apparatus 10 is the transfer destination of the search response packet signal for this terminal apparatus 10.

FIG. 6(c) shows a format of authentication request packet signal and connection request packet signal. These packet signals include a preamble in the physical layer, a MAC header, an IP header, request information, and transfer apparatus IDs. “First terminal apparatus ID” to “third terminal apparatus ID” used as transfer apparatus IDs are IDs similar to those of FIG. 6(b). The content of request information differs depending on the type of packet signal. That is, the content of request information differs depending on whether the packet signal in question is either authentication request packet signal or connection request packet signal. Note that the authentication request and the connection request correspond to a signal in the MAC layer, namely, a second layer. In a configuration as shown in FIG. 1(a), the first terminal apparatus 10a to the base station apparatus 12 are connected on an IP layer, namely a third layer. Accordingly, the signals in the second layer are assigned by the third layer, so that the signals comprised of an IP header, a MAC header and request information (MAC body) are assigned as shown in FIG. 6(c).

FIG. 6(d) shows a format of authentication response packet signal and connection response packet signal. The format shown in FIG. 6(d) is similar to that shown in FIG. 6(c) and therefore the description thereof is omitted here. Note that the content of response information differs depending on the type of packet signal. That is, the content of response information differs depending on whether the packet signal in question is either the authentication response packet signal or the connection response packet signal.

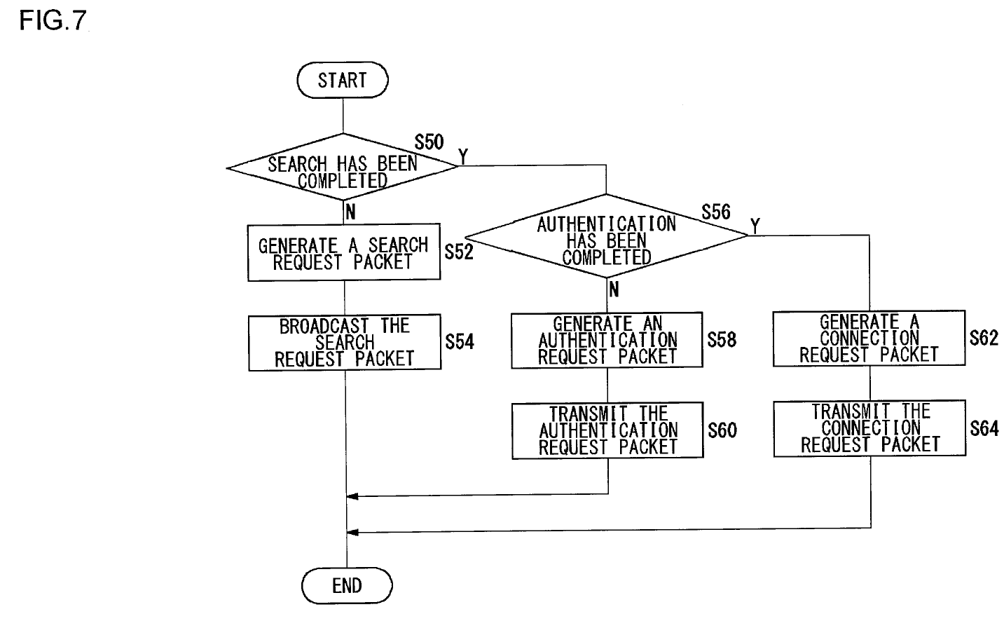

FIG. 7 is a flowchart showing a procedure for transmitting packet signals in the first terminal apparatus 10a. If the search of a base station apparatus has not yet been completed (N of S50), the packet generator 36 generates a search request packet (S52) and the packet transmitter 32 broadcasts the search request packet (S54). If the search of a base station apparatus has been completed (Y of S50) but authentication has not yet been completed (N of S56), the packet generator 36 generates an authentication request packet (S58) and the packet transmitter 32 transmits the authentication request packet (S60). If authentication has been completed (Y of S56), the packet generator 36 generates a connection request packet (S62) and the packet transmitter 32 transmits the connection request packet (S64).

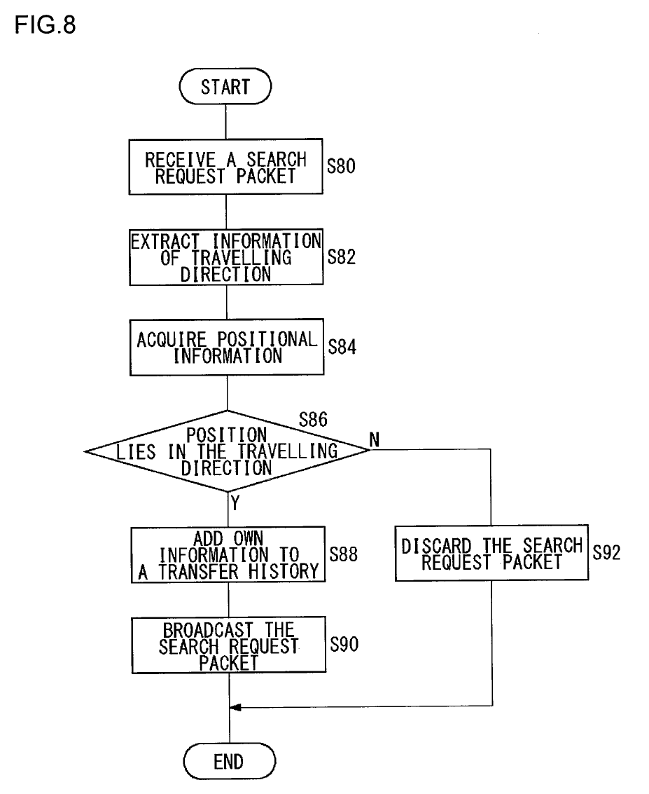

FIG. 8 is a flowchart showing a procedure for transferring a search request packet signal in the second terminal apparatus 10b and the third terminal apparatus 10c. The packet receiver 30 receives the search request packet (S80). The packet processing unit 34 extracts information of the travelling direction from the search request packet (S82) and the vehicle information management unit 26 acquires positional information (S84). If the position lies in the travelling direction (Y of S86), the packet generator 36 will add the own information to a transfer history of search request packets (S88). The transfer history corresponds to the information on the transfer apparatuses shown in FIG. 6(a). The packet transmitter 32 broadcasts the search request packet (S90). If, on the other hand, the position doesn't lie in the travelling direction (N of S86), the packet generator 36 will discard the search request packet (S92).

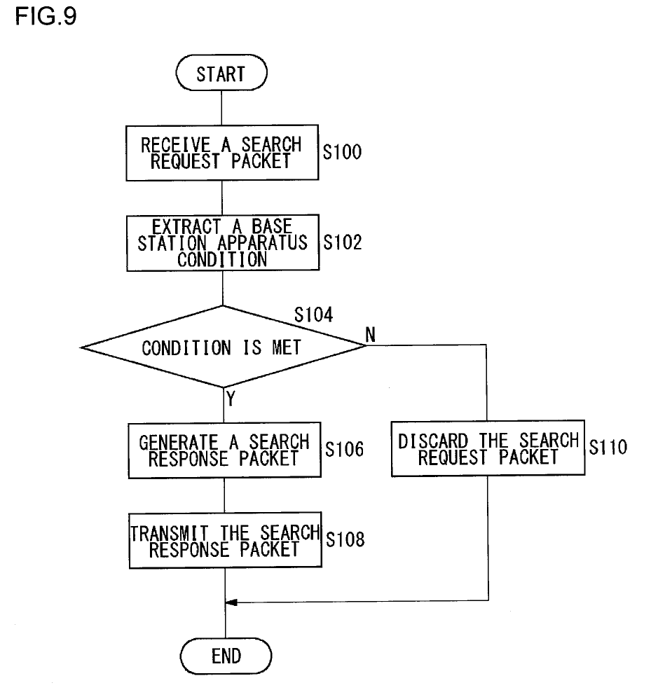

FIG. 9 is a flowchart showing a procedure for processing a search request packet signal and a search response packet signal in the base station apparatus 12. The packet receiver 56 receives the search request packet (S100). The packet processing unit 60 extracts a base station apparatus condition from the search request packet (S102). If the condition is met (Y of S104), the control unit 64 will determine the connection to a terminal apparatus 10 that is the sender of the search request packet, and the packet generator 62 will generate a search response packet (S106). The packet transmitter 58 transmits the search response packet (S108). Note that the destination of the search response packet is determined based on the transfer history contained in the search request packet. If the condition is not met (N of S104), the control unit 64 will discard the search request packet (S110).

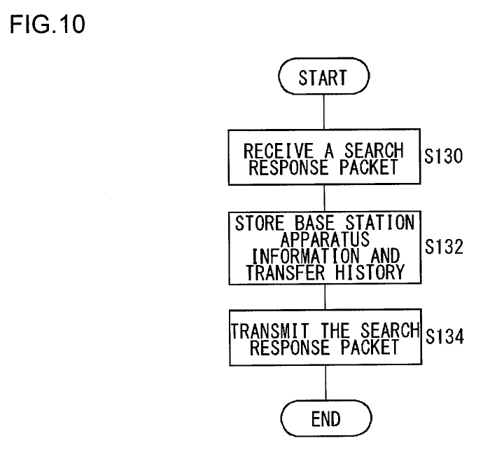

FIG. 10 is a flowchart showing a procedure for transferring a search response packet signal in the second terminal apparatus 10b and the third terminal apparatus 10c.

The packet receiver 30 receives the search response packet (S130). The packet processing unit 34 extracts the base station apparatus information and the transfer history from the search response packet, and the information storage 24 stores the base station apparatus information and the transfer history (S132). The packet transmitter 32 transmits the search response packet (S134).

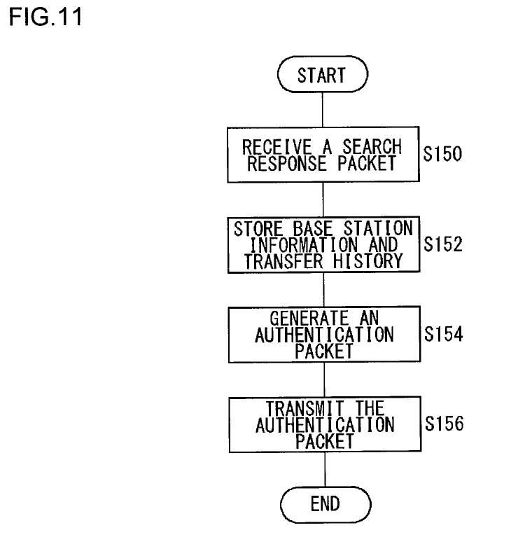

FIG. 11 is a flowchart showing a procedure for processing a search response packet signal and an authentication request packet signal in the first terminal apparatus 10a. The packet receiver 30 receives the search response packet (S150). The packet processing unit 34 extracts the base station apparatus information and the transfer history from the search response packet, and the information storage 24 stores the base station apparatus information and the transfer history (S152). The packet generator 36 generates an authentication request packet (S154). The packet transmitter 32 transmits the authentication request packet (S156). Here, the destination of the authentication request packet is determined based on the transfer history stored in the information storage 24.

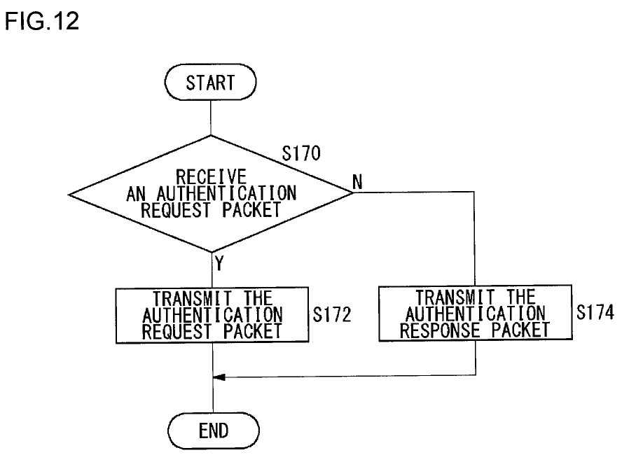

FIG. 12 is a flowchart showing a procedure for transferring an authentication request packet signal or authentication response packet signal in the second terminal apparatus 10b and the third terminal apparatus 10c. Assume herein that the authentication request packet signal or authentication response packet signal is received. If the packet receiver 30 receives the authentication request packet (Y of S170), the packet transmitter 32 will transmit the authentication request packet (S172). If, on the other hand, the packet receiver 30 does not receive the authentication request packet (N of S170), namely if the packet receiver 30 receives the authentication response packet, the packet transmitter 32 will transmit the authentication response packet (S174).

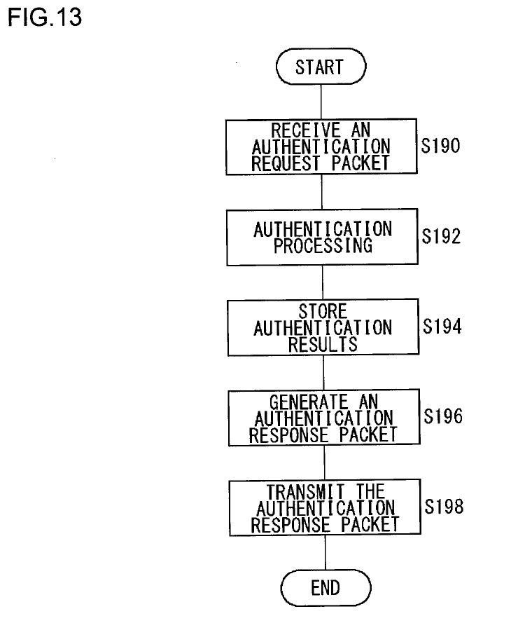

FIG. 13 is a flowchart showing a procedure for processing an authentication request packet signal and an authentication response packet signal in the base station apparatus 12. The packet receiver 56 receives the authentication request packet (S190). The control unit 64 executes authentication processing (S192) and stores the authentication results (S194). The packet generator 62 generates an authentication response packet by including the authentication result therein (S196). The packet transmitter 58 transmits the authentication response packet (S198).

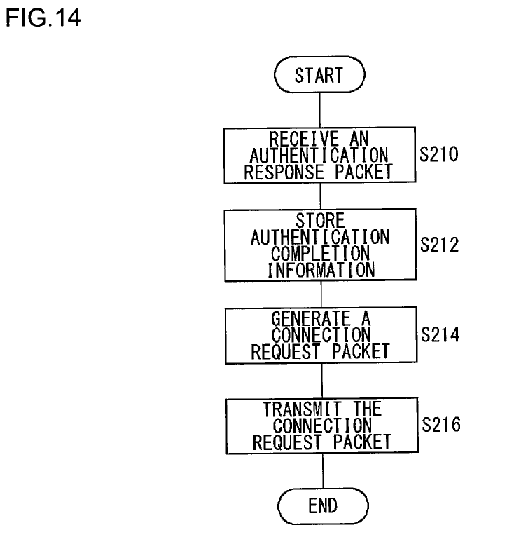

FIG. 14 is a flowchart showing a procedure for processing an authentication response packet signal and a connection request packet signal in the first terminal apparatus 10a. The packet receiver 30 receives the authentication response packet (S210). The packet processing unit 34 extracts authentication completion information from the authentication response packet, and the information storage 24 stores the authentication completion information (S212). The packet generator 36 generates a connection request packet (S214), and the packet transmitter 32 transmits the connection request packet (S216).

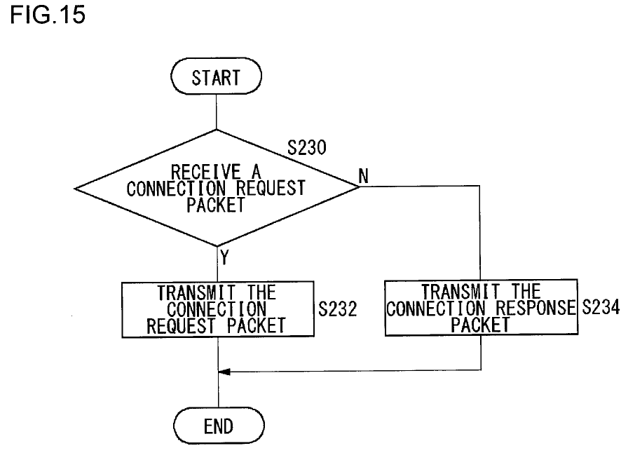

FIG. 15 is a flowchart showing a procedure for transferring a connection request packet signal or connection response packet signal in the second terminal apparatus 10b and the third terminal apparatus 10c. Assume herein that the connection request packet signal or connection response packet signal is received. If the packet receiver 30 receives the connection request packet (Y of S230), the packet transmitter 32 will transmit the connection request packet (S232). If, on the other hand, the packet receiver 30 does not receive the connection request packet (N of S230), namely if the packet receiver 30 receives the connection response packet, the packet transmitter 32 will transmit the connection response packet (S234).

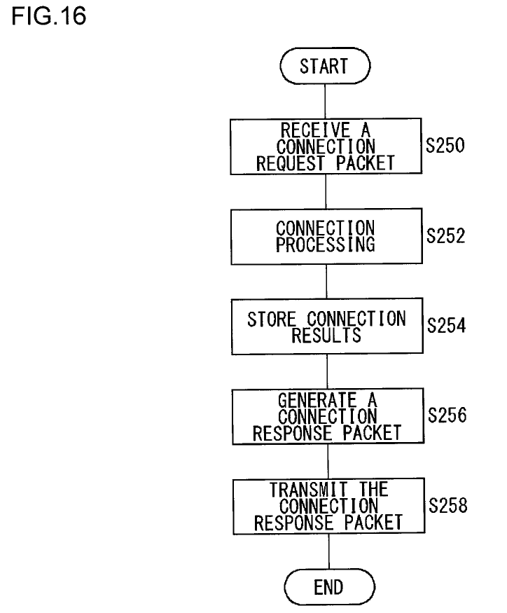

FIG. 16 is a flowchart showing a procedure for processing a connection request packet signal and a connection response packet signal in the base station apparatus 12. The packet receiver 56 receives the connection request packet (S250). The control unit 64 executes the connection processing (S252) and stores the connection results (S254). The packet generator 62 generates a connection response packet by including the connection result therein (S256). The packet transmitter 58 transmits the connection response packet (S258).

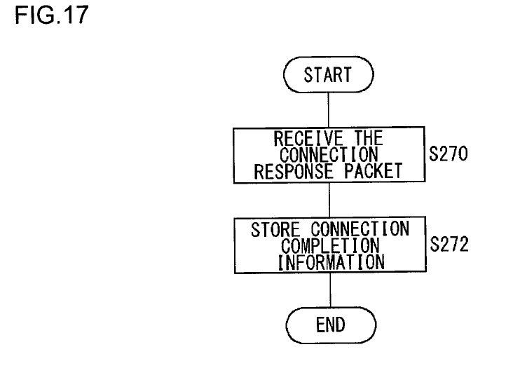

FIG. 17 is a flowchart showing a procedure for receiving a connection response packet signal in the first terminal apparatus 10a. The packet receiver 30 receives the connection response packet (S270). The packet processing unit 34 extracts connection completion information from the connection response packet, and the information storage 24 stores the connection completion information (S272).

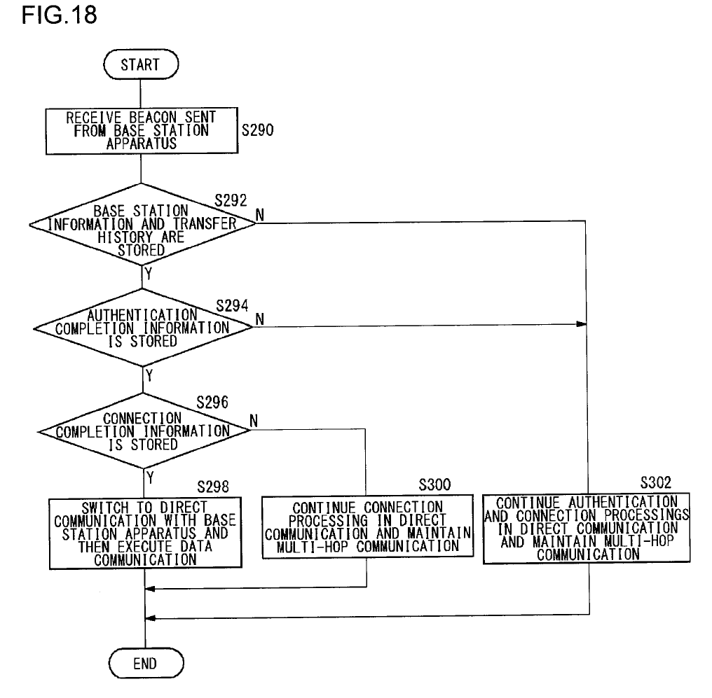

FIG. 18 is a flowchart showing a procedure for processing the first terminal apparatus 10a when the first terminal apparatus 10a enters into a communication area of the base station apparatus 12. The packet receiver 30 receives a beacon sent from the base station apparatus 12 (S290). If the base station information and the transfer history are stored (Y of 5292) in the information storage 24, the authentication completion information is stored therein (Y of 5294) and the connection completion information is stored therein (Y of S296), then the signal processing unit 22 will have the packet communication unit 20 switch the communication mode to the direct communication with the base station apparatus 12 and then instruct the execution of data communication (S298). If, on the other hand, the connection completion information is not stored therein (N of S296), the signal processing unit 22 will instruct the packet communication unit 20 to continue the connection processing in the direct communication and, at the same time, instruct it to maintain the multi-hop communication (S300). If the base station information and the transfer history are not stored therein (N of 5292) in the information storage 24 or the authentication completion information is not stored therein (N of S294), the signal processing unit 22 will instruct the packet communication unit 20 to continue the authentication and connection processings in the direct communication and, at the same time, instruct it to maintain the multi-hop communication (S302).

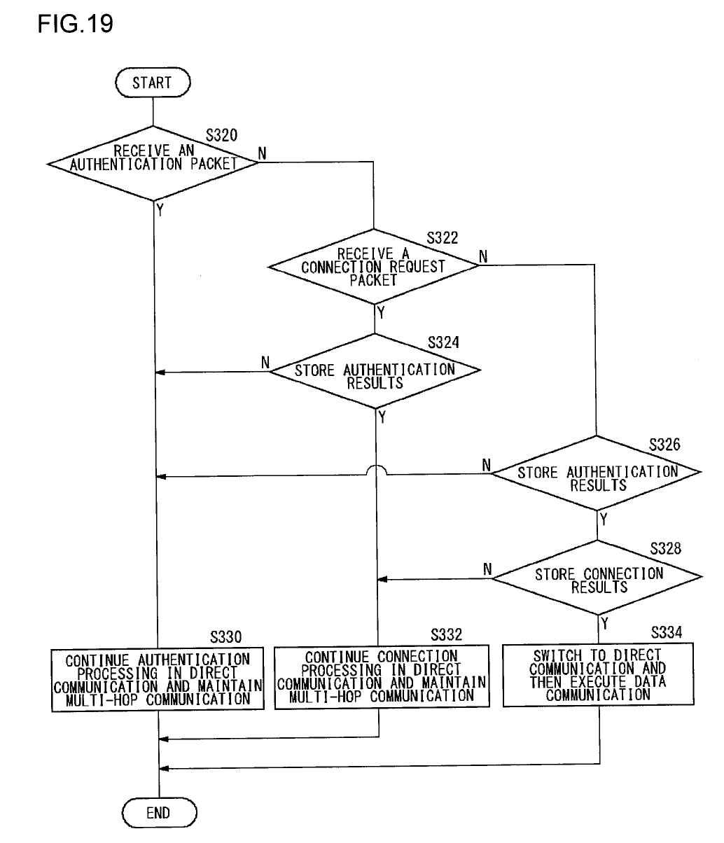

FIG. 19 is a flowchart showing a procedure for processing the base station apparatus 12 when the first terminal apparatus 10a enters into the communication area of the base station apparatus 12. If the packet receiver 56 receives the authentication request packet (Y of S320), the control unit 64 will instruct the packet communication unit 50 to continue the authentication processing in the direct communication and, at the same time, instruct it to maintain the multi-hop communication (S330). If the packet receiver 56 does not receive the authentication request packet (N of S320) but receives the connection request packet (Y of S322)and if the authentication result is stored (Y of S324), the control unit 64 will instruct the packet communication unit 50 to continue the connection processing in the direct communication and, at the same time, instruct it to maintain the multi-hop communication (S332). If, on the other hand, the authentication result is not stored (N of S324), the control unit 64 will instruct the packet communication unit 50 to continue the authentication processing in the direct communication and, at the same time, instruct it to maintain the multi-hop communication (S330).

If the packet receiver 56 does not receive the connection request packet (N of S322), namely if it receives a data-communication start request, the authentication result will be stored (Y of S326). And if the connection result is stored (Y of S328), the control unit 64 will have the packet communication unit 50 switch the communication mode to the direct communication and then instruct the execution of data communication (S334). If, on the other hand, the authentication result is not stored (N of S326), the control unit 64 will instruct the packet communication unit 50 to continue the authentication processing in the direct communication and, at the same time, instruct it to maintain the multi-hop communication (S330). If the connection result is not stored (N of S328), the control unit 64 will instruct the packet communication unit 50 to continue the connection processing in the direct communication and, at the same time, instruct it to maintain the multi-hop communication (S332).

A modification is now described. In the exemplary embodiment, the search processing, the authentication processing and the connection processing are executed in stages. In a path formed by the first terminal apparatus 10a, the second terminal apparatus 10b, the third terminal apparatus 10c and the base station apparatus 12 as shown in FIG. 1(a), the terminal apparatuses 10 are likely to change their respective positions. Accordingly, to prevent the change in the path until the connection processing is completed after the search processing has started, it is preferred that the length of time required until the completion of connection processing from the start of search processing be as short as possible. In this modification, the search processing and the authentication processing are executed in a unified manner. The structure of the communication system 100 according to the modification is of a type similar to that shown in FIGS. 1(a) and 1(b) and therefore the description thereof is omitted here.

The packet generator 36 in the first terminal apparatus 10a generates a search request packet signal and an authentication request packet signal in a unified manner. The packet signal thus generated in a unified manner is called a search authentication request packet signal or a search authentication request packet. The packet transmitter 32 broadcasts the search authentication request packet signal. The second terminal apparatus 10b and the third terminal apparatus 10c transfer the search authentication request packet signal.

The packet receiver 56 in the base station apparatus 12 receives the search authentication request packet signal. The control unit 64 determines the execution of connection processing for the first terminal apparatus 10a, based on the search authentication request packet signal, and at the same time executes authentication processing. The packet generator 62 generates a search authentication response packet signal based on a processing result obtained by the control unit 64, and the packet transmitter 58 transmits the search authentication response packet signal to the third terminal apparatus 10c. The third terminal apparatus 10c and the second terminal apparatus 10b transfer the search authentication response packet signal. The packet receiver 30 in the first terminal apparatus 10a receives the search authentication response packet signal. In the signal processing unit 22 of the first terminal apparatus 10a, the authentication processing is followed by the execution of the connection processing.

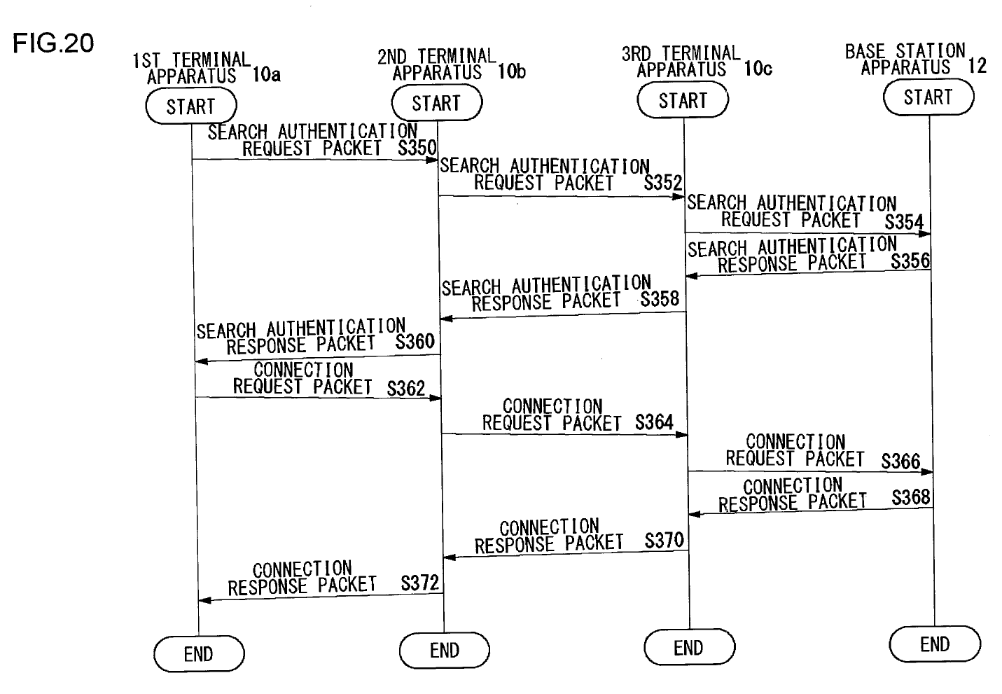

FIG. 20 is a sequence diagram showing a processing procedure up to a connection in this modification. The first terminal apparatus 10a broadcasts a search authentication request packet (350). The second terminal apparatus 10b determines the transfer of the received search authentication request packet, and broadcasts the search authentication request packet (S352). The third terminal apparatus 10c determines the transfer of the received search authentication request packet, and broadcasts the search authentication request packet (S354). The base station apparatus 12 transmits a search authentication response packet signal to the third terminal apparatus 10c (S356). The third terminal apparatus 10c transmits the search authentication response packet signal to the second terminal apparatus 10b (S358). The second terminal apparatus 10b transmits the search authentication response packet signal to the first terminal apparatus 10a (S360).

The first terminal apparatus 10a transmits a connection request packet signal to the second terminal apparatus 10b (S362). The second terminal apparatus 10b transmits the connection request packet signal to the third terminal apparatus 10c (S364). The third terminal apparatus 10c transmits the connection request packet signal to the base station apparatus 12 (S366). The base station apparatus 12 connects the first terminal apparatus 10a and then transmits a connection response packet signal to the third terminal apparatus 10c (S368). The third terminal apparatus 10c transmits the connection response packet signal to the second terminal apparatus 10b (S370). The second terminal apparatus 10b transmits the connection response packet signal to the first terminal apparatus 10a (S372).

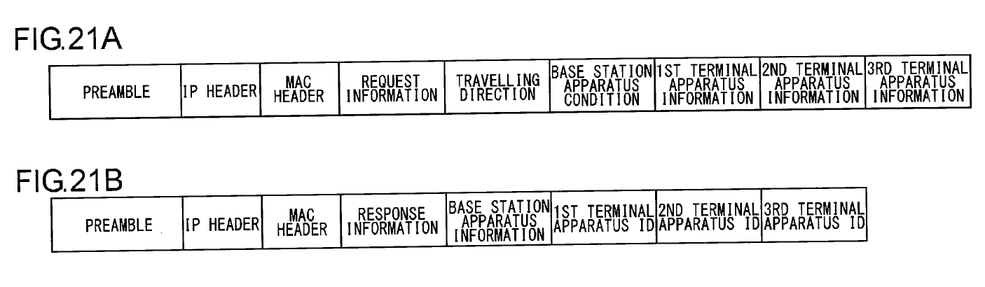

FIGS. 21(a) and 21(b) each shows a structure of packet signal transmitted by the communication system 100.

FIG. 21(a) corresponds to a format of search authentication request packet signal. The format shown in FIG. 21(a) corresponds to a structure that combines the format shown in FIG. 6(c) with the format shown in FIG. 6(a). Thus the description thereof is omitted here. FIG. 21(b) corresponds to a format of search authentication response packet signal. The format shown in FIG. 21(b) corresponds to a structure that combines the format shown in FIG. 6(d) with the format shown in FIG. 6(b). Thus the description thereof is omitted here.

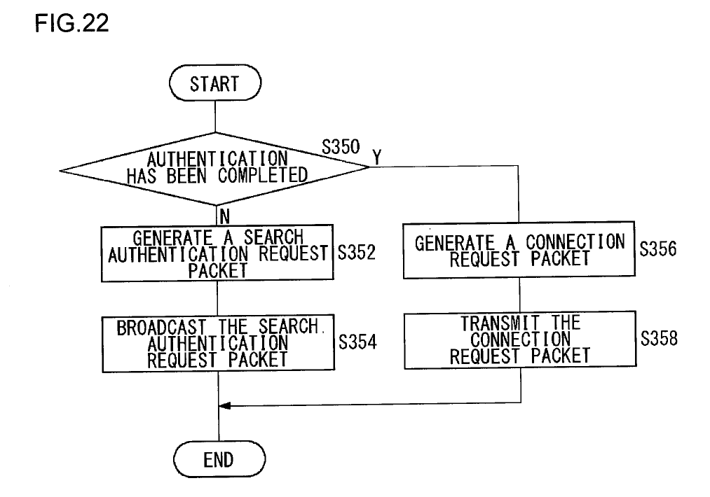

FIG. 22 is a flowchart showing a procedure for transmitting a packet signal in the first terminal apparatus 10a. If authentication has not yet been completed (N of S350), the packet generator 36 generates a search authentication request packet (S352) and the packet transmitter 32 broadcasts the search authentication request packet (S354). If authentication has been completed (Y of S350), the packet generator 36 generates a connection request packet (S356) and the packet transmitter 32 transmits the connection request packet (S358).

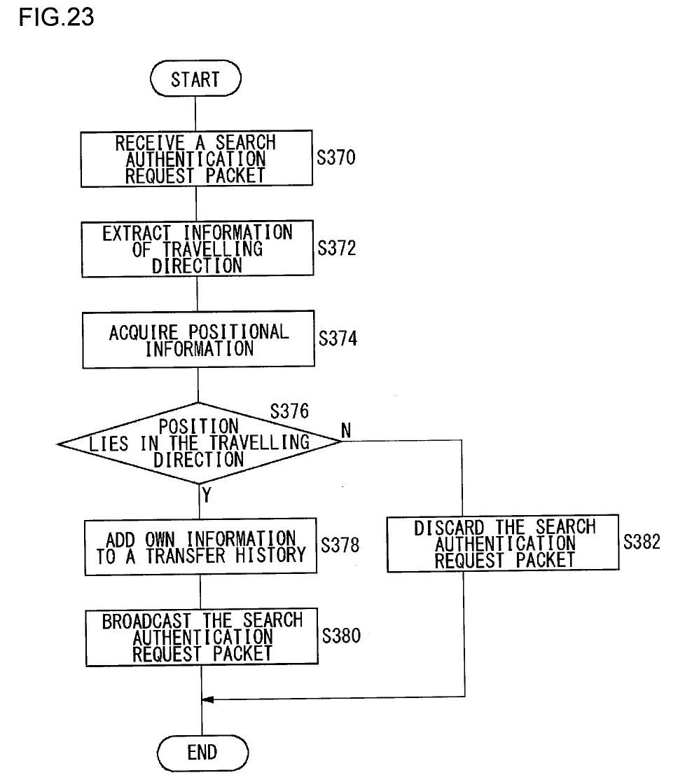

FIG. 23 is a flowchart showing a procedure for transferring a search authentication request packet signal in the second terminal apparatus 10b and the third terminal apparatus 10c. The packet receiver 30 receives the search authentication request packet (S370). The packet processing unit 34 extracts information of the travelling direction from the search authentication request packet (S372) and the vehicle information management unit 26 acquires positional information (S374). If the position lies in the travelling direction (Y of S376), the packet generator 36 will add the own information to the transfer history of search authentication request packets (S378). The packet transmitter 32 broadcasts the search authentication request packet (S380). If, on the other hand, the position doesn't lie in the travelling direction (N of S376), the packet generator 36 will discard the search authentication request packet (S382).

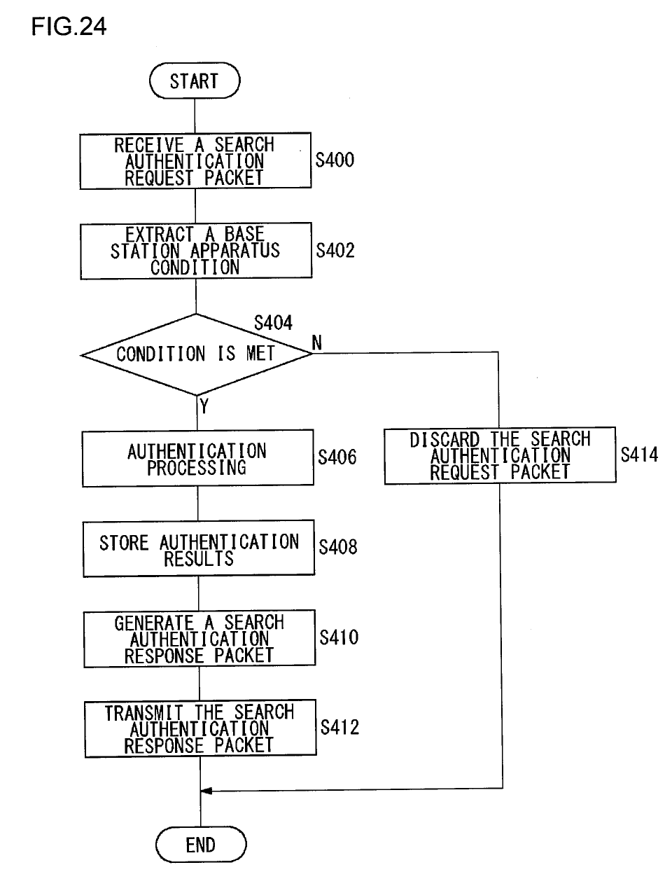

FIG. 24 is a flowchart showing a procedure for processing a search authentication request packet signal and a search authentication response packet signal in the base station apparatus 12. The packet receiver 56 receives the search authentication request packet (S400). The packet processing unit 60 extracts a base station apparatus condition from the search authentication request packet (S402). If the condition is met (Y of S404), the control unit 64 will execute authentication processing (S406) and stores the authentication results (S408). Also, the control unit 64 determines a connection to a terminal apparatus 10 that is the sender of the search authentication request packet, and the packet generator 62 will generate a search authentication response packet (S410). The packet transmitter 58 transmits the search authentication response packet (S412). If the condition is not met (N of S404), the control unit 64 will discard the search authentication request packet (S414).

By employing the exemplary embodiment of the present invention, communication is performed between a terminal apparatus and a base station apparatus by way of a transfer apparatus or transfer apparatuses, so that communication can be performed even outside the communication area of the base station apparatus. The connection processing is performed between the terminal apparatus and the base station apparatus by way of the transfer apparatus or transfer apparatuses, so that the connection processing can be performed in advance therebetween even outside the communication area of the base station apparatus. Since the connection processing is performed in advance therebetween, the length of time needed for connection processing in the communication area can be shortened. Since the search request packet signal that contains the condition for a base station apparatus to be communicated and the condition for a transfer apparatus that is to transfer the search request packet signal is broadcast, the base station apparatus and the transfer apparatus that meet the conditions can be searched. When a direct radio communication with the base station apparatus becomes feasible, the direct radio communication is executed. Thus, the normal radio communication can be executed. If the connection processing has not yet been completed, the direct radio communication is executed and, at the same time, the multi-hop communication is also kept. Thus, the data communication can be executed continuously. Since the search processing and the connection processing are carried out in a unified manner, the length of time required for the both processings can be shortened.

Also, since the connection processing is performed between another terminal apparatus and a base station apparatus by way of the transfer apparatus that has already been communicating wirelessly with the base station apparatus, the connection processing can be performed between the terminal apparatus and the base station apparatus even outside the communication area of the base station apparatus. Also, the length of time for connection processing can be reduced. Since the condition for a base station to be communicated is received, the communication between a terminal apparatus and the base station apparatus that has satisfied the condition can be provided. As direct radio communication between the terminal apparatus and the base station apparatus becomes feasible, the direct radio communication is executed. Thus the normal wireless communication can be executed.

The present invention has been described based on the exemplary embodiment. The exemplary embodiment is intended to be illustrative only, and it is understood by those skilled in the art that various modifications to constituting elements and processes could be developed and that such modifications are also within the scope of the present invention.

### INDUSTRIAL APPLICABILITY

The length of time needed for connection processing between a base station apparatus and a terminal apparatus in a communication area formed by the base station apparatus can be reduced.

1. A terminal apparatus, comprising:
a communication unit which executes radio communication in such a manner as to be accessible to another terminal apparatus that has already been communicating wirelessly with a base station apparatus; and
a processing unit which generates a signal to be transmitted from said communication unit to the base station apparatus by way of the another terminal apparatus and which processes a signal received from the base station apparatus by way of the another terminal apparatus.

2. A terminal apparatus, comprising:
a communication unit which executes radio communication in such a manner as to be accessible to another terminal apparatus that has already been communicating wirelessly with a base station apparatus; and
a processing unit which generates a connection request signal to be transmitted from said communication unit to the base station apparatus by way of the another terminal apparatus and which executes connection processing between the base station apparatus and a terminal apparatus in such a manner that a connection response signal received from the base station apparatus by way of the another terminal apparatus is processed by said communication unit.

3. A terminal apparatus according to claim 2, wherein prior to the connection processing, said communication unit broadcasts a searching signal to search for a base station apparatus to be communicated and at least one of other terminal apparatuses included in a path to the base station apparatus, and
wherein said processing unit generates the searching signal in such a manner that a condition for the base station apparatus to be communicated and a condition for the at least one of other terminal apparatuses that is to transfer the searching signal are contained in the searching signal.

4. A terminal apparatus according to claim 3, wherein said processing unit generates the searching signal and the connection request signal in a unified manner.

5. A terminal apparatus according to claim 2, further comprising a detector which detects that a direct radio communication becomes feasible between said communication unit and the base station apparatus,
wherein when a detection has been made by said detector, said communication unit executes the direct radio communication with the base station apparatus.

6. A terminal apparatus according to claim 5, wherein when the detection has been made by said detector and the connection processing has been completed, said processing unit has said communication unit execute the direct radio communication with the base station apparatus using a connection processing result, and
when the detection has been made by said detector but the detection processing has not been completed, said processing unit has said communication unit complete the connection processing by directly communicating wirelessly with the base station apparatus and has said communication unit maintain radio communication performed by way of the another terminal apparatus.

7. A base station apparatus, comprising:
a communication unit which executes radio communication with a terminal apparatus; and
a processing unit which executes connection processing for a terminal apparatus that is to communicate wirelessly with said communication unit,
wherein said communication unit receives a connection request signal from another terminal apparatus by way of a terminal apparatus that has already been communicating wirelessly with the base station apparatus, and
wherein said processing unit executes connection processing for the another terminal apparatus, based on the connection request signal received by said communication unit, and
said processing unit transmits a connection response signal from said communication unit to the another terminal apparatus by way of the terminal apparatus.

8. A base station apparatus according to claim 7, wherein prior to the connection processing, said communication unit receives a searching signal to search for a base station apparatus to be communicated, the searching signal having been transferred by the terminal apparatus after transmitted by the another terminal apparatus, and
wherein said processing unit includes a means for determining the execution of connection processing for the another terminal apparatus when a condition, for the base station apparatus to be communication, contained in the searching signal received by said communication unit is met, and
by referencing information, on a terminal apparatus that has transferred the searching signal, contained in the searching signal received by said communication unit, said processing unit transmits a response signal for the searching signal to said terminal apparatus.

9. A base station apparatus according to claim 8, wherein the searching signal and the connection request signal received by said communication unit are generated in a unified manner, and
wherein said processing unit determines the execution of connection processing for the another terminal apparatus and executes the connection processing.

10. A base station apparatus according to claim 7, further comprising a detector which detects that a direct radio communication becomes feasible between said communication unit and the another terminal apparatus,
wherein when a detection has been made by said detector, said communication unit executes the direct radio communication with the another station apparatus.

11. A base station apparatus according to claim 10, wherein when the detection has been made by said detector and the connection processing has been completed, said processing unit has said communication unit execute the direct radio communication with the another terminal apparatus using a connection processing result, and
when the detection has been made by said detector but the detection processing has not been completed, said processing unit has said communication unit complete the connection processing by directly communicating wirelessly with the another terminal apparatus and has the communication unit maintain radio communication performed by way of the terminal apparatus.

12. A communication method, comprising:
executing radio communication in such a manner as to be accessible to another terminal apparatus that has already been communicating wirelessly with a base station apparatus;
generating a signal to be transmitted to the base station apparatus by way of the another terminal apparatus; and
processing a signal received from the base station apparatus by way of the another terminal apparatus.
